(19) United States
(12) Patent Application Publication
(10) Pub. No.: US 2006/0238853 A1
(43) Pub. Date: Oct. 26, 2006

(54) Method of producing light control film

(75) Inventors: Junji Morimoto, Osaka (JP); Sang Jin Lee, Niihama-shi (JP); Yasuhiro Watanabe, Niihama-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited

(21) Appl. No.: 11/406,233

(22) Filed: Apr. 19, 2006

(30) Foreign Application Priority Data
Apr. 22, 2005 (JP) 2005-124721

(51) Int. Cl. G02B 26/00

(52) U.S. Cl. 359/296

(57) ABSTRACT

A method of producing a light control film, wherein the method comprises the steps of; irradiating a composition in the form of sheet containing at least two compounds each having a polymerizable carbon-carbon bond in the molecule and having mutually different refractive indices with ultraviolet ray via an interference filter 0 to 60% transmittance at a wavelength of 313 nm, and hardening the composition.

### TECHNICAL FIELD OF THE INVENTION

The present invention relates to a method of producing a light control film.

### BACKGROUND OF THE INVENTION

Light control films selectively scattering only incident light in a certain angle region to give high haze value (opacity) and allowing permeation of incident light in other angle regions to give low haze value (transparency) are used as optical films such as a viewing angle control film pasted to a windowpane for protecting privacy, a cash dispenser touch panel and the like, a viewing angle enlarging film of a flat panel display, and the like.

As a method of producing such a light control film, there is disclosed, for example, a method of irradiating a film of a photopolymerizable composition with ultraviolet ray having a wavelength of 400 nm or less. Specifically, a light control film is known having an opaque angle region of 40% or more haze values of 45.1° obtained by irradiation with ultraviolet ray via an interference filter allowing permeation of about 70 to 80% of a wavelength of 313 nm (Japanese Patent Application Laid-Open (JP-A) No. 6-11606 [Claim 1], [0025](Example 4), [0030][Table 1], [FIG. 3])).

Recently, for further enlarging viewing angle control range, development of a light control film capable of scattering incident light in a wider range is being required.

### DISCLOSURE OF THE INVENTION

The present invention has an object of providing a method of producing a light control film, capable of further enlarging an opaque angle region of 40% or more haze values.

The present inventors have studied to find a method of producing a light control film, capable of further enlarging a visual angle control range and resultantly found that a light control film capable of scattering incident light in a wider range can be produced by irradiation with ultraviolet ray via an interference filter having a transmittance at a wavelength of 313 nm of 0 to 60%.

That is, the present invention provides the following [1] to [6].
[1] A method of producing a light control film, wherein the method comprises the steps of;

irradiating a composition in the form of sheet containing at least two compounds each having a polymerizable carbon-carbon bond in the molecule and having mutually different refractive indices with ultraviolet ray via an interference filter allowing 0 to 60% transmittance at a wavelength of 313 nm, and

hardening the composition.
[2] The method according to [1], wherein the interference filter is a filter allowing 0 to 60% transmittance at a wavelength of 313 nm and allowing 40 to 100% transmittance at a wavelength of 303 nm.
[3] The method according to [1] or [2], wherein a difference in refractive index between at least two compounds contained in the composition in the form of sheet is 0.01 or more.
[4] The method according to [1] to [3], wherein the compound having a polymerizable carbon-carbon double bond in the molecule further contains a photoinitiator.
[5] A light control film having an opaque angle region of 40% or more haze values of 50° or more, obtained by irradiating a composition in the form of sheet containing at least two compounds each having a polymerizable carbon-carbon bond in the molecule and having mutually different refractive indices with ultraviolet ray, and hardening the composition.
[6] The light control film according to [5], wherein a difference (αₐ−α_{b}) between the minimum inclination angle αₐ and the maximum inclination angle α_{b} at the section of a light control film observed by an optical microscope is 10° or more.
[7] The light control film according to [5] or [6], wherein the minimum inclination angle αₐ is less than 90° and the maximum inclination angle α_{b} is 90° or more.

### BRIEF EXPLANATION OF DRAWINGS

FIG. 1 is a schematic view of a method of measuring angle dependency of haze value.

FIG. 2A is a side elevation view of an ultraviolet ray hardening apparatus, and FIG. 2B is a perspective view of an ultraviolet ray hardening apparatus.

FIG. 3 shows a method of taking out a film piece for observing the maximum inclination angle and the minimum inclination angle.

FIG. 4 shows a layer of a fine structure of the section of a film piece observed by an optical microscope (schematic view).

FIG. 5 is a graph showing relation between transmittance and wavelength of interference filters used in examples and comparative examples.

FIG. 6 is a graph showing relation between incidence angle and haze value of light control films obtained Examples 1 and 2 and Comparative Example 1.

FIG. 7 is a photograph of the section of a film piece cut out from a light control film obtained in Example 1.

FIG. 8 is a photograph of the section of a film piece cut out from a light control film obtained in Example 2.

FIG. 9 is a photograph of the section of a film piece cut out from a light control film obtained in Comparative Example 1.

### DESCRIPTION OF MARKS

1 light control film on glass plate
2 light source (ultraviolet lamp in the form of rod)
3 shading plate
4 slit provided on shading plate
5 interference filter
6 conveyer
7 film pierce cut out from light control film
8 layer of fine structure in light control film
9 relation between wavelength and transmittance of interference filter used in Example 1
10 relation between wavelength and transmittance of interference filter used in Example 1
11 releation between incidence light and haze value of light control film in Example 1
12 relation between incidence light and haze value of light control film in Example 2
13 relation between incidence light and haze value of light control film in Comparative Example 1

### MODES FOR CARRYING OUT THE INVENTION

The present invention will be illustrated in detail below.

The compound contained in the composition in the form of sheet used in the present invention is a compound having a polymerizable carbon-carbon bond in the molecule and examples thereof include compounds having a vinyl group, allyl group, styryl group, acryloyl group, methacryloyl group, acrylamide group, trans-1-oxo-2-butenoxy group, cinnamoyl group, butadiene structure, polymerizable conjugated bond, cycloolefin structures such as cyclopentene ring structure and the like. Of them, compounds having an acryloyl group, methacryloyl group are preferable, and compounds having an acryloyl group are more preferable.

The compound having a polymerizable carbon-carbon bond in the molecule may be a monomer compound or oligomer compound.

Examples of the monomer compound include compounds having one polymerizable carbon-carbon double bond in the molecule such as tetrahydrofurfuryl acrylate, ethylcarbitol acrylate, dicyclopentenyl oxyethyl acrylate, phenylcarbitol acrylate, nonylphenoxy ethyl acrylate, 2-hydroxy-3-phenoxy propyl acrylate, ω-hydroxyhexanoyl oxyethyl acrylate, acryloyl oxyethyl succinate, acryloyl oxyethyl phthalate, isobornyl acrylate, 2-ethylhexyl acrylate, lauryl acrylate, 2,2,3,3-tetrafluoropropyl acrylate, phenylcarbitol acrylate, nonylphenoxy ethyl acrylate, 2-hydroxy-3-phenoxy propyl acrylate, 2,4,6-tribromophenoxy ethyl acrylate, 2,4,6-tribromophenyl acrylate, N-vinylpyrrolidone, N-acryloylmorpholine, methacrylate monomers corresponding to these acrylates, and the like, and

compounds having a plurality of polymerizable carbon-carbon double bonds in the molecule such as triethylene glycol diacrylate, polyethylene glycol diacrylate, neopentyl glycol diacrylate, 1,6-hexanediol diacrylate, hydrogenated dicyclopentadienyl diacrylate, trimethylolpropane triacrylate, pentaerythritol hexaacrylate, ethylene oxide-modified bisphenol A diacrylate, trisacryloxy isocyanurate, poly-functional epoxy acrylate, poly-functional urethane acrylate, methacrylates corresponding to these acrylates, diethylene glycol bisallyl carbonate, divinylbenzene, triallyl isocyanurate and the like.

The compound having a polymerizable carbon-carbon bond in the molecule may be compound having an aromatic ring and a polymerizable carbon-carbon double bond in the molecule, and it is preferable to use no compound having a plurality of aromatic rings and one polymerizable carbon-carbon double bond in the molecule.

Examples of the oligomer compound include polyester acrylates, polyol polyacrylates, modified polyol polyacrylates, polyacrylates having an isocyanuric acid skeleton, melamine acrylate, polyacrylates having a hydantoin skeleton, polybutadiene acrylate, epoxy acrylate, poly-functional acrylates such as urethane acrylate oligomer and the like, methacrylates corresponding these acrylates, and the like.

As the urethane acrylate oligomer, exemplified are those produced by an addition reaction of a polyisocyanate, polyol and 2-hydroxyalkyl(meth)acrylate. Here, examples of the polyisocyanate include toluene diisocyanate, isophorone diisocyanate, trimethylhexamethylene diisocyanate, hexamethylene diisocyanate and the like. Examples of the polyol include polyether polyols such as polyethylene glycol, polypropylene glycol, polytetramethylene glycol and the like.

The composition in the form of sheet contains at least two compounds selected from these compounds having a polymerizable carbon-carbon bond in the molecule, and these compounds have mutually different refractive indices and when its difference in refractive index is larger, the haze value of the resulting light control film becomes higher.

Two compounds have a difference in refractive index of preferably at least 0.01, more preferably at least 0.02. When three or more compounds are used, it is preferable that any two of the compounds to be used satisfy the above-mentioned condition regarding the difference in refractive index. The mixing ratio of two compounds showing a difference in refractive index of at least 0.01 is preferably in a range of 10:90 to 90:10 by weight. It is preferable that compatibility of these compounds is lower.

The composition in the form of sheet may contain, for example, polymers such as polystyrene, polymethyl methacrylate, polyethylene oxide, polyvinylpyrrolidone, polyvinyl alcohol, nylon and the like, organic chemicals such as toluene, n-hexane, cyclohexane, methyl alcohol, ethyl alcohol, acetone, methyl ethyl ketone, tetrahydrofuran, ethyl acetate, dimethylformamide, dimethylacetamide, acetonitrile and the like, plastic additives such as organic halogen compounds, organic silicon compounds, plasticizers, stabilizers and the like, providing photocontrollability is not prevented.

The composition in the form of sheet can be obtained by sheet formation by a method of applying such monomer compounds and the like on a base plate such as a glass plate, polyethylene terephthalate plate and the like, a method of filling such monomer compounds and the like in a cell, or other methods.

The composition in the form of sheet usually has a thickness of about 25 μm to 1000 μm, a width of about 5 cm to 300 cm, and a length of about 5 cm to several hundreds m.

Compositions in the form of sheet deprived of oxygen such as a composition in the form of sheet obtained by filling in a cell do not necessarily require a photoinitiator, however, as compositions in the form of sheet obtained by general methods such as a method of applying on a base plate, and the like, a composition in the form of sheet containing a photoinitiator previously mixed is preferably used for improving degree of hardening.

Examples of the photoinitiator include benzophenone, benzil, Michler's ketone, 2-chlorothioxanetone, 2,4-diethylthioxanetone, benzoin methyl ether, benzoin ethyl ether, diethoxyacetophenone, benzyl dimethyl ketal, 2-hydroxy-2-methylpropiophenone, 1-hydroxycyclohexyl phenyl ketone and the like.

The use amount of the photoinitiator is usually about 0.01 to 5 parts by weight, preferably about 0.1 to 3 parts by weight, based on 100 parts by weight of the composition in the form of sheet.

In the production method of the present invention, a light control film is produced by irradiating the above-mentioned composition in the form of sheet with ultraviolet ray via an interference filter showing a transmittance of ultraviolet ray of a wavelength of 313 nm of 0 to 60%, preferably 1 to 50%, more preferably 2 to 40%.

The interference filter shows a transmittance of ultraviolet ray of a wavelength of 313 nm of 0 to 60% and preferably shows a transmittance of ultraviolet ray of a wavelength of 303 nm of 40 to 100%, more preferably 50 to 90%, further preferably 60 to 85%.

The interference filter preferably shows a transmittance of ultraviolet ray of a wavelength of 313 nm of 1 to 50% and preferably shows a transmittance of ultraviolet ray of a wavelength of 303 nm of 40 to 100%, more preferably 50 to 90%, further preferably 60 to 85%.

The interference filter more preferably shows a transmittance of ultraviolet ray of a wavelength of 313 nm of 2 to 40% and preferably shows a transmittance of ultraviolet ray of a wavelength of 303 nm of 40 to 100%, more preferably 50 to 90%, further preferably 60 to 85%.

Specifically mentioned is a method in which light of a light source 2 in the form of rod is irradiated as a beam along vertical direction from a slit of a shading plate 3 via an interference filter 5 as in an ultraviolet hardening apparatus in FIG. 2, and a composition 1 in the form of sheet applied on a glass plate is placed on a conveyer 6, and conveyed usually at a rate of about 0.01 to 10.0 m/min, preferably about 0.1 to 5.0 m/min while gradually hardening this, or the like.

The interference filter 5 can be prepared, for example, by appropriately selecting a base material, the kind and thickness of a metal layer (or film) to be vapor-deposited, and a vapor deposition substance of a transparent film constituting an intermediate layer and a control layer so that the transmittance of ultraviolet ray of a wavelength of 313 nm is 0 to 60% as described in detail in “Shiro Fujiwara, Kogaku Gijutsu Series 11, Kogaku Hakumaku, 6-th chapter, Sekkei no Jissai, 6.2 Kansho Filter, Kyoritsu Shuppan (1985)”.

The interference filter 5 is designed, for example, using a quartz plate or the like as the base material and using gold, silver, aluminum or the like as the metal layer (or film) to be deposited, so that it allows most significant permeation of light of specific wavelength when its film thickness is ½ or integer-fold of the specific wavelength.

As the intermediate layer and control layer of the interference filter 5, for example, transparent dielectric films and the like are used. As the transparent dielectric film, transparent dielectric films of low refractive index and high refractive index are usually used in multi-layers.

Specific examples of the interference filter include metal interference filters, whole dielectric film interference filters, dielectric metal film interference filters, plasma ion coat band pass filters and the like, and these may be used in combination of two or more.

The light used in producing a light control film is ultraviolet ray having a wavelength of 313 nm. Used as the light source of ultraviolet ray are light sources in the form of rod such as a mercury lamp, metal halide lamp and the like, a lot of point light sources sequentially arranged in linear form, linear light sources such as a light source of scanning light from laser ray or the like using a revolution mirror and a concave mirror (irradiation from different lot of angles to one irradiated position), and the like. Of them, the light source in the form of rod is preferable because of easy handling.

The composition in the form of sheet shows anisotropy for the major axis direction and the minor axis direction, and scatters light at a specific angle only when the composition in the form of sheet is shifted along the minor axis direction of the light source. Namely, it is believed that, in the composition in the form of sheet, regions of difference refractive indices form layers of fine structure periodically present under condition of orientation parallel to the major axis direction of the light source, and incidence light from a specific angle is scattered in a region of different refractive index.

The light control film of the present invention is a light control film having a width of an opaque angle region of 40% or more haze values of 50° or more, preferably 60° to 140°, and for example, can be obtained by the above-mentioned production method.

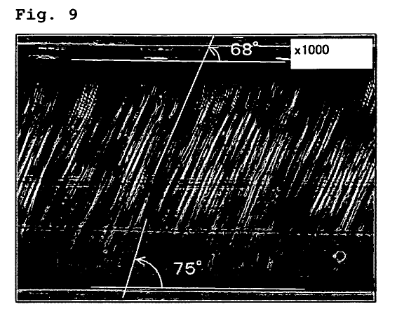

In conventional light control films as described in JP-A No. 6-11606, it is believed that intense light quantity is imparted to a composition in the form of sheet to cause quick hardening, therefore, layers of fine structure observed in the section of the film are formed approximately in linear form as shown in FIG. 9.

On the other hand, when the light control film of the present invention is observed by an optical microscope at the section of the film along the minor axis direction of a light source, layers of continuous or discontinuous fine structure are usually formed so as to draw an arc as shown in a schematic view of FIG. 4. It is believed by this fact that only incidence light from a specific angle is selectively scattered and incidence light from other angles permeates.

In the production method of the present invention, ultraviolet ray having a wavelength of 313 nm is used via an interference filter showing a transmittance of 0 to 60%, thus, it is believed that intense light quantity is not imparted to a composition in the form of sheet and the composition is hardened slowly, thereby forming layers of fine structure so as to draw an arc.

The light control film of the present invention has layers of fine structure in which a difference (α_{b}−αₐ) between the maximum inclination angle α_{b} and the minimum inclination angle αₐ of the section of a film observed by an optical microscope is usually 10° or more, preferably 20° or more, more preferably 30° or more. When this difference is 10° or more, a width of the opaque angle region tends to increase preferably.

When this difference (α_{b}−αₐ) is 20°, that is, when the minimum inclination angle αₐ is 80° and the maximum inclination angle α_{b} is 100° and when 90° intervenes between the minimum inclination angle αₐ and the maximum inclination angle α_{b}, the resulting light control film has an opaque angle region at the front, as a result, the light control film can be suitably used for optical films such as a viewing angle enlarging film of a flat panel display.

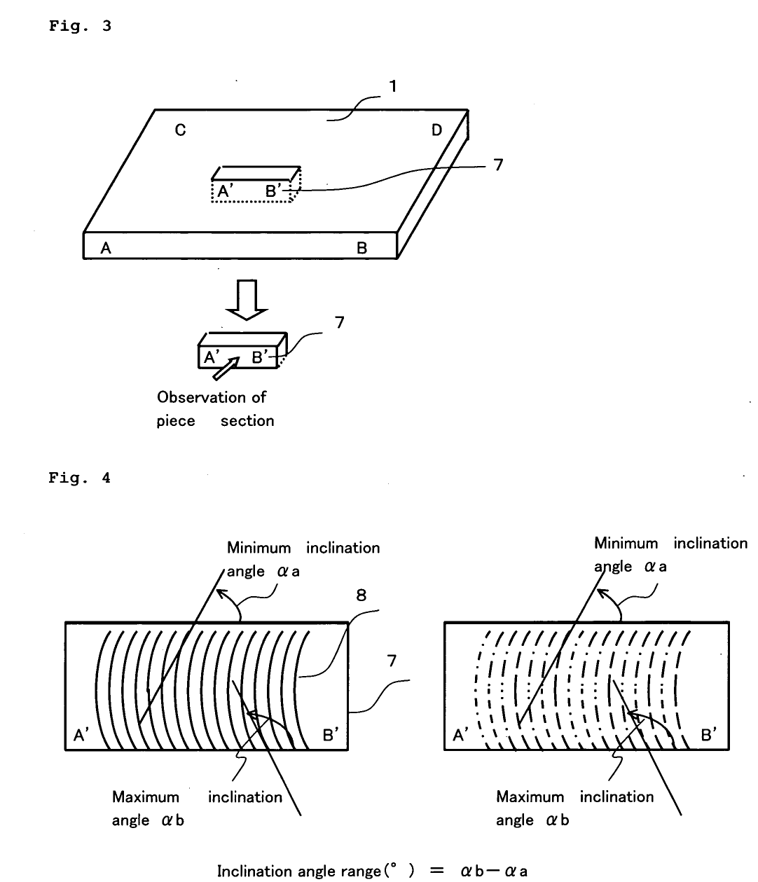

Here, in a method of measuring the minimum inclination angle αₐ, first, as shown in FIG. 3, a film piece 7 is cut out at approximately the center of a light control film, subsequently, shaved by a microtome, cutter knife and the like so that the section (A′B′ surface) can be observed by an optical microscope, the section of the resulting slice is photographed by an optical microscope having a magnification of usually about 400 to 2000-fold, preferably 1000-fold, and the minimum angle can be selected as the minimum inclination angle αₐ among angles formed by a surface irradiated by a light source and a layer of fine structure formed of a surface irradiated by a light source. In a method of measuring the maximum inclination angle α_{b}, the maximum angle can be selected as the maximum inclination angle α_{b} among angles formed by a surface not irradiated by a light source and a layer of fine structure formed of a surface not irradiated by a light source, in the same section (photograph).

According to the present invention, a light control film having an enlarged opaque angle region can be obtained by a simple production method of only changing the transmittance of an interference filter.

### EXAMPLES

The present invention will be illustrated further in detail below based on examples, but it is needless to say that the present invention is not limited to these examples.

The whole beam transmittance and the diffusion transmittance of a light control film were measured using an integrating sphere mode beam transmittance measuring apparatus (Haze value Guard Plus 4725 manufactured by Gardner) at a distance of 4 cm between the center of the light control film and an integrating sphere, and the haze value is measured by the following formula.
Haze value (%)=(diffusion transmittance (%)/whole beam transmittance (%))×100
Diffusion transmittance=whole beam transmittance−parallel beam transmittance

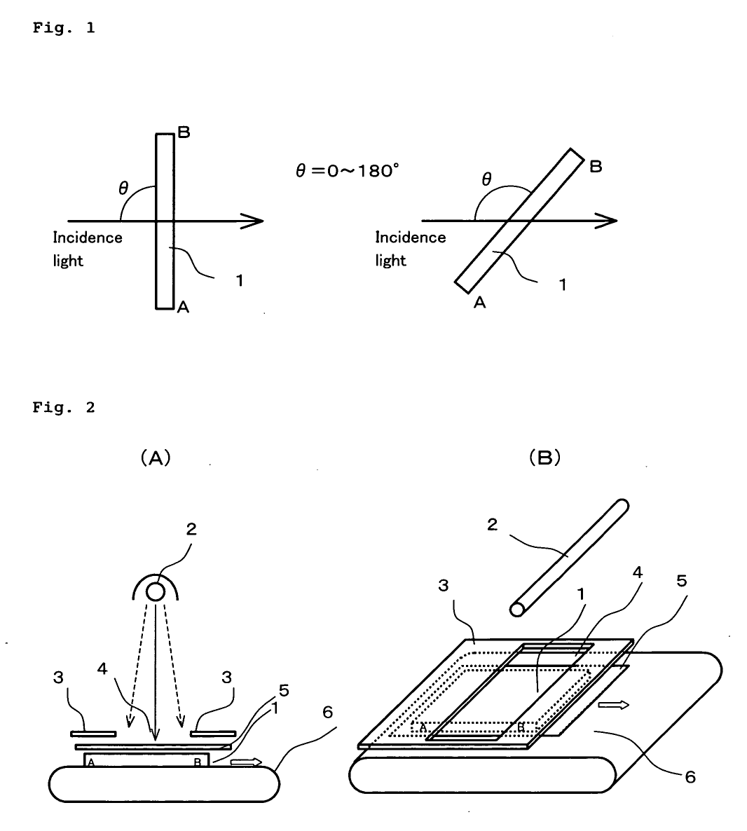

The angle dependency of haze value in a light control film is measured as described below. That is, as shown in FIG. 1, the angle θ of incidence light into a specimen 1 of the light control film is changed between 0 to 180°, and the above-mentioned haze value is measured for every angle. Here, the angle θ is a value when a direction parallel to a surface of the specimen 1 is 0° and the normal line direction of the specimen 1 is 90°, and rotation of the specimen 1 is carried out toward a direction at which the angle dependency of haze value is maximum. A and B in the figures are marks imparted to teach the corresponding part of the specimen 1 between the left figure (light is directed to specimen 1 from vertical direction: θ=90°) and the right figure (light is directed to specimen 1 from inclined direction).

### Example 1

On a transparent polyethylene terephthalate (PET) base plate was applied a resin composition at a thickness of 350 μm obtained by adding and mixing 30 parts by weight 2,4,6-tribromophenyl acrylate, 30 parts by weight of 2-hydroxy-3-phenoxy propyl acrylate (refractive index: 1.526) and 1.5 parts by weight of 2-hydroxy-2-methylpropiophenone to 40 parts by weight of polyether urethane acrylate (refractive index: 1.460) obtained by reaction of polypropylene glycol having an average molecular weight of about 3000 with 0.3 mol of toluene diisocyanate, 2.7 mol of hexamethylene diisocyanate and 2 mol of 2-hydroxyethyl acrylate per 2 mol of the polypropylene glycol.

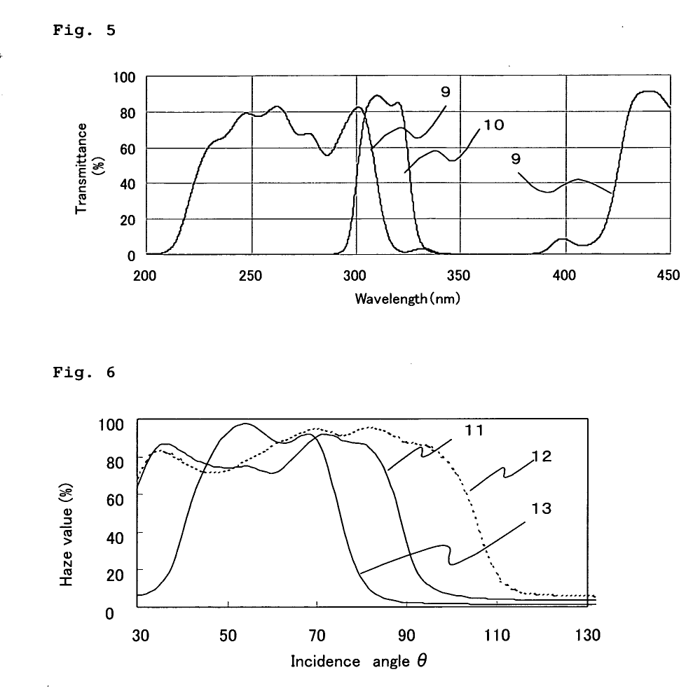

The resulting composition in the form of sheet was irradiated with ultraviolet ray using an apparatus shown in FIG. 2. The composition in the form of sheet and PET base plate are endowed with mark 1 in FIG. 2. In the figure, a light source 2 represents a 80 W/cm mercury lamp in the form of rod, 3 represents a shading plate, 4 represents a slit, 5 represents an interference filter and 6 represents a conveyer. On the conveyer 6, the PET base plate 5 carrying an applied composition in the form of sheet was placed and transferred toward an arrow direction at constant speed (0.6 m/min). The shading plate 3 is placed so that ultraviolet ray from the light source is irradiated through the interference filter 5 (254 filter manufactured by EYE Graphics Co., Ltd.) (relation between wavelength and transmittance shown in 9 in FIG. 5) allowing 22.5% permeation of 313 nm and 80.8% permeation of 303 nm. The transmission spectrum of the interference filter 5 is represented by mark 9 in FIG. 5.

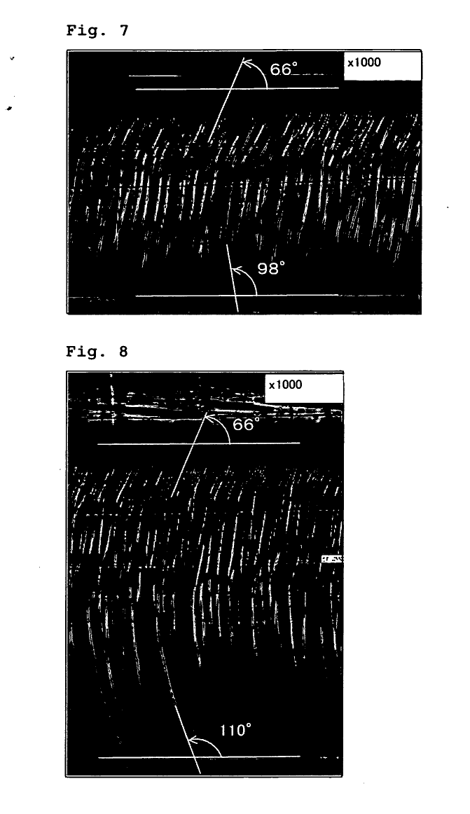

The resultant light control film was subjected to measurement of haze value together with the PET base plate. The haze value of the PET base plate itself can be ignored. The incidence angle dependency of haze value when the angle (θ) of incidence light is changed as shown in FIG. 1 is measured, and the result is described in FIG. 6. In FIG. 1, an arrow shows the direction of incidence light, and marks A and B appended to a light control film correspond to A and B in FIG. 1, respectively. From the haze value curve in FIG. 6, the maximum haze value and opaque angle width showing haze values of 40% or more are obtained and described in Table 1.

Using the resultant light control film, the center portion of the sample was cut out by a cutter together with a PET base plate, further, A′B′ section to be observed was shaved by a rotary microtome (HM355 manufactured by MICROM), and the section of this slice was photographed at a magnification of 1000-fold using a digital microscope (VH-8000, VH-Z450, manufactured by Keyence Corporation). The resultant segment photograph of the light control film is shown in FIG. 7. The maximum inclination angle α_{b} was 98° and the minimum inclination angle αₐ was 66°, its difference being 32°.

### Example 2

A light control film was obtained in the same operation as in Example 1 except that the thickness of the composition in the form of sheet was changed from 350 μm to 570 μm. From the haze value curve of this light control film, the maximum haze value and opaque angle width showing haze values of 40% or more are obtained and described in Table 1. The photograph of the section of the resulting hardened film is shown in FIG. 8. The maximum inclination angle α_{b} was 110° and the minimum inclination angle αₐ was 66°, its difference being 44°.

### Comparative Example 1

A light control film was obtained in the same operation as in Example 1 except that an interference filter allowing 86.9% permeation of 313 nm and 66.8% permeation of 303 nm (313 filter manufactured by Optical Coatings Japan) (relation between wavelength and transmittance shown in 10 in FIG. 5) was used instead of the interference filter allowing 22.5% permeation of 313 nm and 80.8% permeation of 303 nm. From the haze value curve of this light control film, the maximum haze value and opaque angle width showing haze values of 40% or more are obtained and described in Table 1. The photograph of the section of the resulting hardened film is shown in FIG. 8. The maximum inclination angle α_{b} was 75° and the minimum inclination angle αₐ was 68°, its difference being 7°.

### Example 3

A light control film was obtained in the same operation as in Example 1 except that an interference filter allowing 2.1% permeation of 313 nm and 63.5% permeation of 303 nm (300 filter manufactured by Optical Coatings Japan) was used instead of the interference filter allowing 22.5% permeation of 313 nm and 80.8% permeation of 303 nm. From the haze value curve of this light control film, the maximum haze value was 92.1% and opaque angle width showing haze values of 40% or more was 74°.

TABLE 1

| | | | | Opaque angle |
|---|---|---|---|---|
| | | | | width |
| | | | | (°) (width of |
| | Band pass | | Haze value | angle region of |
| | filter (313 nm | | (maximum | 40% or more |
| | transmittance) | α_{b} − αₐ | value %) | haze values) |
| Example 1 | 22.5% | 32° | 92.1% | >60° |
| Example 2 | 22.5% | 44° | 95.3% | >77° |
| Comparative | 86.9% | 7° | 97.6% | 36° |
| Example 1 | | | | |

### INDUSTRIAL APPLICABILITY

The light control film of the present invention can also be coated or pasted on a transparent base material such as a glass plate, other plastic sheets and the like. A laminate of this transparent base material and light control film can be suitably used as an optical film for, e.g., building material windows, vehicle windows, mirrors, green house outer wall materials, plat panel displays, rear projection displays and the like.

1. A method of producing a light control film, wherein the method comprises the steps of;
irradiating a composition in the form of sheet containing at least two compounds each having a polymerizable carbon-carbon bond in the molecule and having mutually different refractive indices with ultraviolet ray via an interference filter allowing 0 to 60% transmittance at a wavelength of 313 nm, and
hardening the composition.

2. The method according to claim 1, wherein the interference filter is a filter allowing 0 to 60% transmittance at a wavelength of 313 nm and allowing 40-100% transmittance at a wavelength of 303 nm.

3. The method according to claim 1, wherein a difference in refractive index between at least two compounds contained in the composition in the form of sheet is 0.01 or more.

4. The method according to claim 1, wherein the compound having a polymerizable carbon-carbon double bond in the molecule further contains a photoinitiator.

5. A light control film having an opaque angle region of 40% or more haze values of 50° or more, obtained by irradiating a composition in the form of sheet containing at least two compounds each having a polymerizable carbon-carbon bond in the molecule and having mutually different refractive indices with ultraviolet ray, and hardening the composition.

6. The light control film according to claim 5, wherein a difference (aₐ−α_{b}) between the minimum inclination angle αₐ and the maximum inclination angle α_{b} at the section of a light control film observed by an optical microscope is 10° or more.

7. The light control film according to claim 5, wherein the minimum inclination angle αₐ is less than 90° and the maximum inclination angle α_{b} is 90° or more.
